(19) United States
(12) Patent Application Publication
(10) Pub. No.: US 2024/0086509 A1
(43) Pub. Date: Mar. 14, 2024

(54) INFORMATION PROCESSING DEVICE, INFORMATION PROCESSING METHOD, AND INFORMATION PROCESSING PROGRAM

(71) Applicant: SONY GROUP CORPORATION, TOKYO (JP)

(72) Inventors: YOSHIAKI IWAI, TOKYO (JP); JIANING WU, TOKYO (JP); NATSUKO OZAKI, TOKYO (JP); SAYAKA WATANABE, TOKYO (JP); JUN YOKONO, TOKYO (JP)

(21) Appl. No.: 18/261,108

(22) PCT Filed: Jan. 5, 2022
(86) PCT No.: PCT/JP2022/000082

§ 371 Date: Jul. 11, 2023

(30) Foreign Application Priority Data
Jan. 19, 2021 (JP) 2021-006593

(51) Int. Cl. G06F 21/32

(52) U.S. Cl. CPC G06F 21/32

(57) ABSTRACT

An information processing device (1) includes a registration information storage unit (112), an acquisition unit (122), a presentation unit (123), and a registration unit (124). The registration information storage unit (112) stores registration information related to an object to be a recognition target. The acquisition unit (122) acquires attribute information indicating a property of a new object to be a recognition target in accordance with a message of advice received from a user. The presentation unit (123) presents the attribute information acquired by the acquisition unit (122) to the user. In accordance with a registration instruction received from the user, the registration unit (124) associates attribute information with name information designated by the user, and registers the associated information in the registration information storage unit (112) as registration information.

### FIELD

The present disclosure relates to an information processing device, an information processing method, and an information processing program.

### BACKGROUND

Robots that have been conventionally developed to play various roles include housework robots that perform housework such as cleaning at home, pet robots that behave like pets, and transport robots in factories and distribution warehouses.

Some of such robots are trained to perform recognition of an unknown object through an image or language. For example, Patent Literature 1 discloses an information processing device that generates, in a case where an object is an unknown object, feedback information for prompting a user to change the posture of the object being the unknown object, and notifies the user of feedback based on the feedback information. This information processing device extracts features of an unknown object candidate region on the basis of a plurality of viewpoint images based on different postures of the unknown object.

### CITATION LIST

### Patent Literature

Patent Literature 1: JP 2019-192145 A

### SUMMARY

### Technical Problem

However, while the above-described conventional technique extracts features of the unknown object candidate region on the basis of a plurality of viewpoint images based on different postures of the unknown object, information obtained by learning of the image is limited, and thus there is room for improvement in object recognition accuracy.

In view of this, the present disclosure proposes an information processing device, an information processing method, and an information processing program capable of improving object recognition accuracy.

### Solution to Problem

To solve the above problem, an electronic device that provides a service that requires an identity verification process according to an embodiment of the present disclosure includes: an information processing device comprising: a registration information storage unit that stores registration information related to an object to be a recognition target; an acquisition unit that acquires attribute information indicating a property of a new object to be a recognition target in accordance with a message of advice received from a user; and a presentation unit that presents the attribute information acquired by the acquisition unit to a user; and a registration unit that associates the attribute information with name information designated by the user in accordance with a registration instruction received from the user and that registers the associated information in the registration information storage unit as the registration information.

### BRIEF DESCRIPTION OF DRAWINGS

FIG. 1 is a diagram illustrating a configuration example of an information processing system according to an embodiment of the present disclosure.

FIG. 2 is a diagram illustrating an outline of information processing according to an embodiment of the present disclosure.

FIG. 3 is a block diagram illustrating a schematic hardware configuration example of a robot according to an embodiment of the present disclosure.

FIG. 4 is a block diagram illustrating a functional configuration example of a robot according to an embodiment of the present disclosure.

FIG. 5 is a diagram illustrating an outline of information stored in a user information storage unit according to an embodiment of the present disclosure.

FIG. 6 is a diagram illustrating an outline of information stored in a registration information storage unit according to an embodiment of the present disclosure.

FIG. 7 is a diagram illustrating an outline of processing of a robot in registration processing according to an embodiment of the present disclosure.

FIG. 8 is a diagram illustrating an outline of processing of a robot in registration processing according to an embodiment of the present disclosure.

FIG. 9 is a diagram illustrating an outline of processing of a robot in registration processing according to an embodiment of the present disclosure.

FIG. 10 is a flowchart illustrating an example of a registration processing procedure performed by a robot according to an embodiment of the present disclosure.

FIG. 11 is a flowchart illustrating an example of a recognition processing procedure performed by a robot according to an embodiment of the present disclosure.

FIG. 12 is a diagram illustrating a configuration example of an information processing system according to a modification.

### DESCRIPTION OF EMBODIMENTS

Embodiments of the present disclosure will be described below in detail with reference to the drawings. Redundant descriptions will be omitted from the present embodiment in some cases by assigning the same numbers or reference signs to components having substantially the same functional configuration. Moreover, in the present specification and the drawings, a plurality of components having substantially the same functional configuration will be distinguished in some cases by attaching different numbers or reference signs after the same numbers or reference signs.

The description of the present disclosure will be made according to the following order.
1. One embodiment
1-1. System configuration example
1-2. Overview of information processing
2. Hardware configuration example of robot
3. Functional configuration example of robot
4. Specific example of registration processing performed by robot
5. Example of processing procedure performed by robot
5-1. Registration processing
5-2. Recognition processing
6. Modification
6-1. Case of registration processing
6-2. Case of recognition processing
7. Others
8. Conclusion

### 1. ONE EMBODIMENT

An embodiment of the present disclosure described below assumes application to an information processing system including an autonomous mobile body equipped with various sensors, such as a domestic pet robot, a humanoid robot, a robotic vacuum cleaner, an unmanned aerial vehicle, a tracking conveyance robot, and an automobile equipped with a self-driving function. Furthermore, application targets of the embodiment described below is not limited to such a system. For example, the embodiment is applicable to various devices capable of driving (including sound production, light emission, and the like) by autonomous or remote operation, such as a movable portion like a robot arm or a manipulator having a drive mechanism, and a smart speaker having an interactive communication function, or a system including such devices.

### 1-1. System Configuration Example

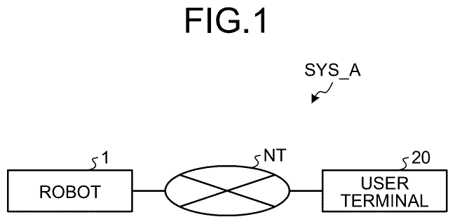

FIG. 1 is a diagram illustrating a configuration example of an information processing system according to an embodiment of the present disclosure. As illustrated in FIG. 1, an information processing system SYS A according to an embodiment of the present disclosure (hereinafter, appropriately referred to as “the present embodiment”) includes a robot 1 and a user terminal 20. The information processing system SYS A may include more robots 1 and user terminals 20 than in the example illustrated in FIG. 1.

The robot 1 and the user terminal 20 are connected to a network NT. The robot 1 and the user terminal 20 can communicate with each other through the network NT. The network NT can be implemented by applying, for example, various networks such as the Internet, a LAN, and a mobile communication network.

The robot 1 is typically a domestic pet robot or a humanoid robot, and implements motions in accordance with an instruction from a user.

The user terminal 20 is an electronic device such as a smartphone, a tablet, or a personal computer. The user terminal 20 has a communication function for communicating with the robot 1 through the network NT.

### 1-2. Overview of Information Processing

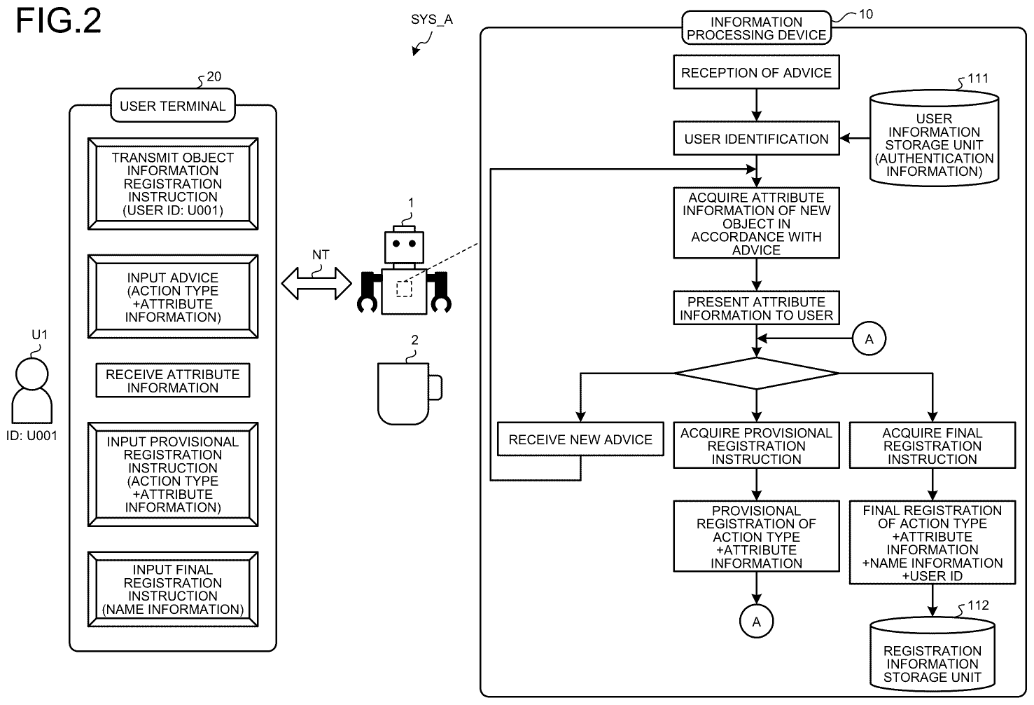

FIG. 2 is a diagram illustrating an outline of information processing according to an embodiment of the present disclosure. FIG. 2 illustrates an outline of processing for registering, in the robot 1, information related to an object to be newly set as a recognition target. In the present embodiment, a user U1 gives a piece of advice for prompting the robot 1 to acquire attribute information indicating a property of an object to be newly registered as a recognition target (hereinafter, referred to as a “new object”) through interaction with the robot 1. This makes it possible for the user U1 to register, in the robot 1, information considered to be useful for recognizing the new object.

As illustrated in FIG. 2, the user U1 transmits various instructions and various types of advice to the robot 1 using the user terminal 20. For example, an object information registration instruction is transmitted to instruct the robot 1 to start processing of registering the attribute information of a new object 2. The advice is transmitted to give the robot 1 a combination of the action type and the attribute information for prompting the robot 1 to acquire the attribute information of the new object 2. For example, a provisional registration instruction is transmitted to prompt the robot 1 to perform provisional registration of the attribute information acquired by the robot 1 according to the advice from the user U1. In addition, a final registration instruction is transmitted to prompt the robot 1 to perform final confirmation registration of the attribute information acquired by the robot 1 according to the advice from the user U1. Furthermore, the user U1 receives attribute information from the robot 1 using the user terminal 20. With this operation, the user U1 can observe the action of the robot 1, check whether the information acquired by the robot 1 is appropriate, and can consider alteration of the message of the advice.

Furthermore, as illustrated in FIG. 2, the robot 1 includes an information processing device 10 that executes various types of processing of the robot 1. When having received the object information registration instruction from the user terminal 20, the information processing device 10 transitions to a registration processing mode for internally registering object information, and waits until advice or an instruction is issued from the user U1. For example, the information processing device 10 activates a camera, a microphone, or the like included in the robot 1 in response to the reception of the object information registration instruction. Furthermore, the information processing device 10 acquires user ID unique to the user U1 from the object information registration instruction.

After having received the advice from the user U1, the information processing device 10 refers to a user information storage unit 111 and identifies the user U1 who has issued the advice on the basis of authentication information corresponding to the user ID. The authentication information to be adopted may be any information that can be acquired by the robot 1 from the user U1, including any character string such as a password, image information such as a face image, and biometric information.

After the user identification, the information processing device 10 controls the motion of the robot 1 so as to take an action according to the message of the advice received from the user U1, and acquires the attribute information from the new object 2. The information processing device 10 presents (transmits) the acquired attribute information to the user terminal 20 and waits until the next instruction or advice is given.

Furthermore, having acquired a new pieces of advice from the user U1, the information processing device 10 controls the motion of the robot 1 to take an action according to the new advice, acquires attribute information from the new object 2, presents the acquired attribute information to the user terminal 20, and waits until the next instruction or advice is given.

Furthermore, when having acquired a provisional registration instruction from the user U1, the information processing device 10 performs provisional registration of a combination of the type of action and the acquired attribute information, and waits until the next instruction or advice is given.

Furthermore, when having acquired a final registration instruction from the user U1, the information processing device 10 associates the combination of the type of action and the acquired attribute information, the name information designated by the user U1, and the user ID with each other, performs final registration of the associated information in a registration information storage unit 112 as the registration information related to the new object 2, and ends the object information registration processing.

That is, the information processing device 10 additionally acquires the attribute information each time advice is received from the user. Furthermore, every time the attribute information is acquired, the information processing device 10 newly presents the acquired attribute information to the user U1. Furthermore, each time of receiving a provisional registration instruction from the user U1, the information processing device 10 performs additional provisional registration of a combination of the type of action and the attribute information.

As described above, the information processing device 10 controls the motion of the robot 1 so as to take an action according to the message of the advice from the user U1, and acquires attribute information of the new object 2. This enables desired information that the user U1 considers to be useful for recognizing the object to be selectively registered in the information processing device 10 for the new object 2. This leads to achievement of an effect of improving the object recognition accuracy of the information processing device 10. Furthermore, the information processing device 10 can register a plurality of pieces of information as intended by the user U1 to be useful for recognizing an object. This enables object recognition based on a plurality of pieces of attribute information, leading to achievement of an effect of enhancing robustness in object recognition processing.

### 2. HARDWARE CONFIGURATION EXAMPLE OF ROBOT

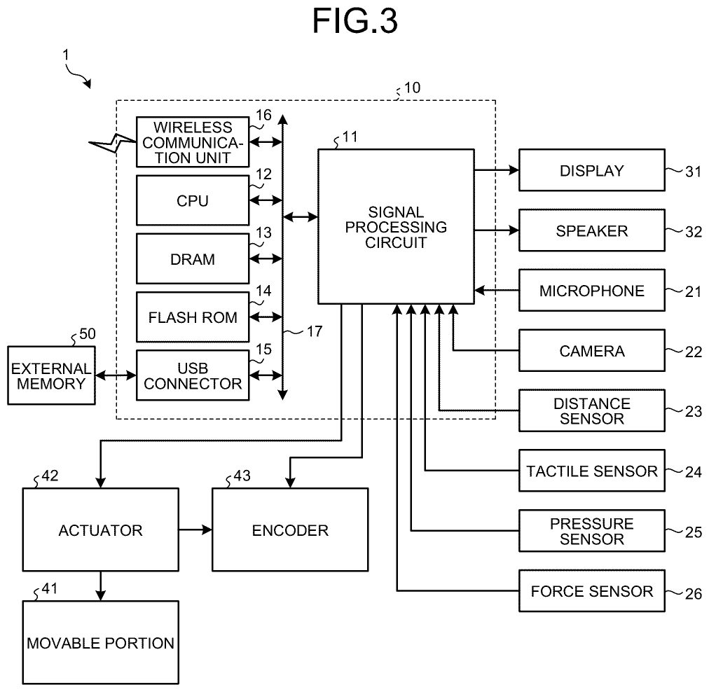

Hereinafter, a hardware configuration of the robot 1 according to the present embodiment will be described. FIG. 3 is a block diagram illustrating a schematic hardware configuration example of a robot according to an embodiment of the present disclosure. Note that FIG. 3 illustrates a schematic configuration example according to the present embodiment, and a configuration other than that illustrated in FIG. 3 may be used.

As illustrated in FIG. 3, the robot 1 includes the information processing device 10. The information processing device 10 has a configuration in which a signal processing circuit 11, a central processing unit (CPU) 12, dynamic random access memory (DRAM) 13, flash read only memory (ROM) 14, a universal serial bus (USB) connector 15, and a wireless communication unit 16 are connected to one another via an internal bus 17. Although not illustrated in FIG. 2, the robot 1 includes devices such as a battery that supplies power to each unit included in the robot 1.

In addition, the robot 1 includes various sensors. For example, as illustrated in FIG. 3, the robot 1 includes a microphone 21, a camera 22, a distance sensor 23, a tactile sensor 24, a pressure sensor 25, and a force sensor 26.

The microphone 21 has a function of collecting ambient sounds. The sound collected by the microphone 21 includes an utterance of the user U1 and a surrounding environmental sound, for example. The robot 1 may include the microphone 21 in plurality.

The camera 22 has a function of imaging a user (for example, the user U1) and a surrounding environment present around the robot 1. For example, the robot 1 can extract feature points and the like of the user or a candidate object that is a target of an action instruction on the basis of an image captured by the camera 22, making it possible to achieve implementation of user identification processing and candidate object recognition processing. Furthermore, by controlling the angle of view of the camera 22, the robot 1 can acquire a multi-view image of an object (for example, the new object 2) to be newly set as a recognition target.

The distance sensor 23 has a function of detecting a distance to an object present around (in front of, for example) the robot 1. On the basis of the distance detected by the distance sensor 23, the robot 1 can implement a motion according to a relative position with respect to an object including the user U1, an obstacle, or the like. The distance sensor 23 can be implemented by a device such as a time of flight (ToF) sensor, a depth sensor (also referred to as a depth camera) that acquires a depth map, a depth image, or the like.

The tactile sensor 24 has a function of detecting contact with an object present around the robot 1 (for example, forward), smoothness (friction coefficient) of an object surface, and the like.

The pressure sensor 25 has a function of detecting pressure. The pressure sensor 25 can detect a pressure acting on the robot 1 (or a part such as a movable portion of a drive mechanism included in the robot 1) in accordance with the motion of the robot 1, for example. The pressure sensor 25 can detect the weight of the gripped object.

The force sensor 26 has a function of detecting a physical quantity such as a strain or a displacement amount of an object and detecting a force corresponding to the detected physical quantity. The force sensor 26 can be implemented by a six-axis force sensor that detects the force in the axial directions of three axes of X, Y, and Z axes as well as the magnitude and direction of the moment of the force. The detection method of the force sensor 26 may be any method such as a strain gauge type, a piezoelectric type, a photoelectric type, or a capacitance type. Furthermore, the force sensor 26 can detect stress corresponding to strain of the detected object and detect hardness (elastic coefficient) of the object on the basis of the detected stress. Furthermore, the force sensor 26 can detect a force and a moment acting on the robot 1 (or a part such as a movable portion included in a drive mechanism of the robot 1) in accordance with the motion of the robot 1, for example.

Note that the various sensors included in the robot 1 are not particularly limited to the example illustrated in FIG. 3. In addition to the above-described sensors, the robot 1 may further include various sensors and devices including a touch sensor, a human sensor, an illuminance sensor, a depth sensor, an ultrasonic sensor, a temperature sensor, a geomagnetic sensor, an inertial measurement unit (IMU), and a global navigation satellite system (GNSS) signal receiver. The configuration of the sensors included in the robot 1 may be flexibly altered according to specifications and operations of the robot 1, processing to be implemented, and the like.

The robot 1 includes a display 31 and a speaker 32 in addition to the various sensors described above.

The display 31 displays various types of information. The display 31 displays information to be notified to the user (for example, the user U1). The display 31 is implemented by a display such as a liquid crystal display (LCD) and an organic electroluminescence display (OELD). The speaker 32 outputs sound. The speaker 32 uses voice to emit information to be notified to a user (for example, the user U1).

In addition, the robot 1 includes a drive mechanism for controlling its own position, posture, action, and the like. This drive mechanism includes: a movable portion 41 including a link (bone portion), a joint (joint portion), and an end effector constituting the robot 1; an actuator 42 for driving the movable portion 41; and an encoder 43 that detects (the position of) the rotation angle of the motor, for example. Furthermore, with achievement of motions in cooperation with the information processing device 10, various sensors, the display 31, a speaker, and the like described above, the drive mechanism functions not only as a mechanism controlling own position, posture, action, and the like, but also as a mechanism for achievement of a motion necessary for own movement or interaction with the user (for example, the user U1), for example.

The above-described various sensors, the display 31, the speaker 32, the actuator 42, and the encoder 43 are connected to the signal processing circuit 11 of the information processing device 10. The signal processing circuit 11 sequentially captures data such as sensor data, image data, and audio data supplied from the above-described various sensors, and sequentially stores the captured data at predetermined positions in the DRAM 13 via the internal bus 17.

The sensor data, the image data, the audio data, and the like stored in the DRAM 13 are used when the CPU 12 performs motion control of the robot 1, and are transmitted to an external device such as a server via the wireless communication unit 16 as necessary. Note that the wireless communication unit 16 has a communication function for communicating with external devices via a predetermined network including a wireless local area network (LAN) such as Bluetooth (registered trademark) or WiFi (registered trademark) or a mobile communication network.

For example, at the initial stage when the robot 1 is powered on, the CPU 12 reads an information processing program stored in external memory 19 connected to the USB connector 15, and stores the read information processing program in the DRAM 13. In addition, the CPU 12 directly reads an information processing program stored in the flash ROM 14, and stores the read information processing program in the DRAM 13.

In addition, the CPU 12 determines the situation of its own device and surroundings, the presence or absence of advice or instructions from the user (for example, the user U1), and the like on the basis of data such as the sensor data, the image data, and the audio data sequentially stored in the DRAM 13 from the signal processing circuit 11 as described above.

In addition, the CPU 12 executes self-position estimation and various motions using various types of information such as map data and action plan information stored in the DRAM 13 or the like. For example, the CPU 12 generates a control command to be given to the actuator 42 on the basis of the map data and the action plan information. The CPU 12 outputs the generated control command to the actuator 42 via the signal processing circuit 11.

In addition, the CPU 12 determines a subsequent action on the basis of the above-described determination result, the self-position estimation result, the control program stored in the DRAM 13, the action plan information, and the like. The CPU 12 drives the actuator 42 on the basis of the determination result to execute various actions such as control of its own position and posture, movement, and interaction.

In addition, the CPU 12 generates audio data as necessary, and provides the generated audio data as an audio signal to the speaker 32 via the signal processing circuit 11. With this operation, the CPU 12 can output sound based on the audio signal from the speaker 32 to the outside. In addition, the CPU 12 generates image data as necessary, and provides the generated image signal to the display 31 via the signal processing circuit 11 as an image signal. This makes it possible for the CPU 12 to display various types of information on the display 31.

In this manner, with cooperative operations of hardware such as the CPU 12 described above and a predetermined program, the robot 1 is configured to be able to autonomously take an action in accordance with its own and surrounding situations, for example, advice and instructions from the user (for example, the user U1), and the like.

### 3. FUNCTIONAL CONFIGURATION EXAMPLE OF ROBOT

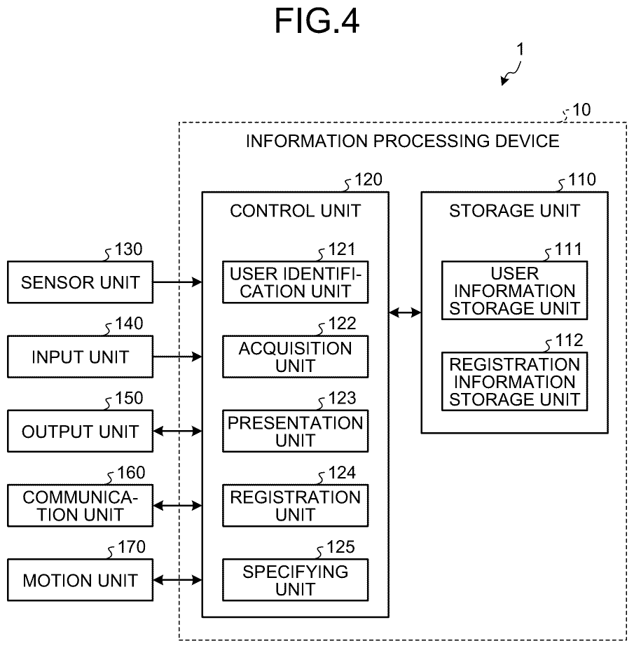

Hereinafter, a functional configuration example of the robot 1 according to an embodiment of the present disclosure will be described. FIG. 4 is a block diagram illustrating a functional configuration example of a robot according to an embodiment of the present disclosure.

As illustrated in FIG. 4, the robot 1 includes a storage unit 110, a control unit 120, a sensor unit 130, an input unit 140, an output unit 150, a communication unit 160, and a motion unit 170. The storage unit 110 and the control unit 120 are included in the information processing device 10 mounted on the robot 1.

The sensor unit 130 includes the camera 22, the distance sensor 23, the tactile sensor 24, the pressure sensor 25, the force sensor 26, and the like described above. The sensor unit 130 transmits the detected data to the control unit 120. The sensor unit 130 functions as a plurality of detection units for acquiring attribute information indicating properties of the recognition target object.

The input unit 140 includes devices such as the microphone 21 described above. The input unit 140 transmits the collected sound data to the control unit 120.

The output unit 150 includes devices such as the display 31 and the speaker 32 described above. The output unit 150 outputs various types of information on the basis of a signal given from the control unit 120.

The communication unit 160 includes devices such as the wireless communication unit 16 described above. The communication unit 160 transmits information transmitted to and received from the user terminal 20 to the control unit 120 through the network NT.

The motion unit 170 includes devices such as the movable portion 41, the actuator 42, and the encoder 43 described above. The motion unit 170 implements motions in accordance with a control command from the control unit 120.

The storage unit 110 includes semiconductor memory elements such as the DRAM 13 and the flash ROM 14 illustrated in FIG. 3 and a storage device such as a hard disk and an optical disk, for example. The storage unit 110 can store, for example, programs, data, and the like for implementing various types of processing to be executed by the control unit 120. The program stored in the storage unit 110 includes an information processing program for implementation of processing functions corresponding to individual portions of the control unit 120. The programs stored in the storage unit 110 include an operating system (OS) and various application programs.

As illustrated in FIG. 4, the storage unit 110 includes a user information storage unit 111 and a registration information storage unit 112.

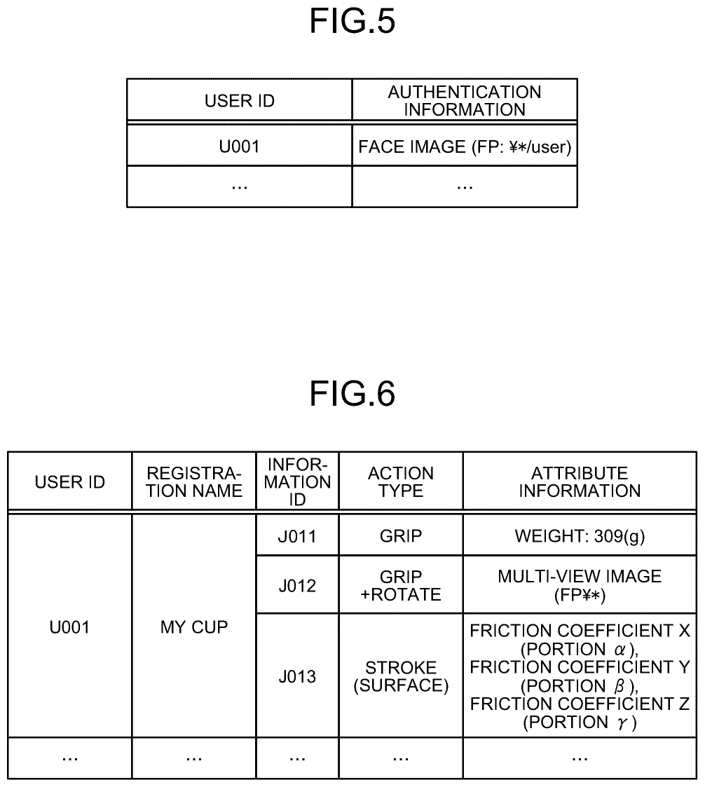

The user information storage unit 111 stores user identification information (user ID) assigned to the user in advance and authentication information unique to the user in association with each other. Here, the user corresponds to the user U1 (refer to FIG. 2) of the user terminal 20, for example. That is, the user is a user who issues advice so that the robot 1 can recognize an object to be newly registered as a recognition target. The user is also a user who interacts with the robot 1 with respect to an object to be a target of an action instruction. FIG. 5 is a diagram illustrating an outline of information stored in a user information storage unit according to an embodiment of the present disclosure.

As illustrated in FIG. 5, the user information storage unit 111 includes an item of “user ID” and an item of “authentication information”, with these items associated with each other. The user ID described above is stored in the item of the user ID. The user ID is preset at the time of registration of use of the robot 1, for example. The authentication information described above is stored in the item of the authentication information. When the authentication information is a face image, for example, it is allowable to store a file path to an image file of the face image stored or store information of features extracted in advance from the face image. The authentication information to be registered in the robot 1 may be in a form that can be optionally selected by the user (for example, the user U1).

The registration information storage unit 112 stores registration information related to an object to be a recognition target. As described above, the registration information is registered by an instruction (final registration instruction) from a user (for example, the user U1) who issued advice to the robot 1 so that a new object as a recognition target can be recognized. FIG. 6 is a diagram illustrating an outline of information stored in a registration information storage unit according to an embodiment of the present disclosure.

As illustrated in FIG. 6, the registration information storage unit 112 includes an item of “user ID”, an item of “registered name”, an item of “information ID”, an item of “type of action”, and an item of “attribute information”, with the items associated with each other.

The item “user ID” stores the same information as the user ID stored in the user information storage unit 111. The item of “registered name” stores the name of the recognition target object. The name of the object is set using a name designated in any manner by the user who issues advice (for example, the user U1) at the time of registering a new object to be set as a recognition target. The item of “information ID” stores identification information for specifying registration information.

The item of “type of action” stores the type of action performed on the new object in accordance with the message of the advice received from the user (for example, the user U1) at the time of registration of the new object as a recognition target. In a case where [grip] is stored in the item of “type of action”, information regarding a part (portion) to be gripped may be stored together. In a case where [grip+rotate] is stored in the item of “type of action”, information regarding the angle of rotation may be stored together. In a case where [stroke (surface)] is stored in the item of “type of action”, information regarding a stroked part (portion) may be stored together.

The item of “attribute information” stores attribute information acquired from a new object as a recognition target by an action performed in accordance with the message of the above-described advice. In a case where [weight] is stored in the item of “attribute information”, the number of digits of the weight may be set to any number. In a case where [multi-view image] is stored in the item of “attribute information”, it is allowable to store a file path to an image file storing a multi-view image, or store information of features extracted from a face image in advance. In a case where [friction coefficient] is stored in the item of “attribute information”, it is allowable to store a corresponding portion associated with each friction coefficient.

The control unit 120 is implemented by devices such as the signal processing circuit 11, the CPU 12, the DRAM 13 illustrated in FIG. 3. Various types of processing executed by the control unit 120 are implemented, for example, by a processor such as the CPU 12 executing a command described in a program read from an internal memory such as the DRAM 13 using the internal memory as a work area. The programs read from the internal memory by the processor such as the CPU 12 include an OS and an application program. Note that the control unit 120 may be implemented by an integrated circuit such as an application specific integrated circuit (ASIC) or a field programmable gate array (FPGA).

As illustrated in FIG. 4, the control unit 120 includes a user identification unit 121, an acquisition unit 122, a presentation unit 123, a registration unit 124, and a specifying unit 125.

The user identification unit 121 identifies a user (for example, the user U1) who has issued the advice on the basis of the above-described authentication information (refer to FIG. 5), and acquires a user ID corresponding to the identified user from among a plurality of user IDs stored in the user information storage unit 111.

In addition, the user identification unit 121 can identify the user who has issued the action instruction (for example, the user U1) on the basis of the authentication information described above (refer to FIG. 5). An example of the action instruction is “take my cup”.

The acquisition unit 122 acquires attribute information indicating the property of the new object to be a recognition target in accordance with the message of the advice received from the user (for example, the user U1). Specifically, the acquisition unit 122 determines a subsequent action on the basis of the own (robot 1) and the surrounding situation, a result of analyzing message of the advice, message of the instruction, and the like from the user, a result of self-position estimation, action plan information, and the like. For example, the acquisition unit 122 decodes message of the advice from the user U1, and determines the own action according to the message of the decoded action. Examples of the type of action to be determined include “detecting a weight by gripping a new object”, “capturing a multi-view image by gripping and rotating a new object”, and “detecting the smoothness (friction coefficient) by stroking the surface of a new object”.

In addition, the acquisition unit 122 can acquire the attribute information from the candidate object that is the target of the action instruction by acting in accordance with the type of action associated with the user identified by the user identification unit 121 in the registration information stored in the registration information storage unit 112.

The presentation unit 123 presents the attribute information acquired by the acquisition unit 122 to the user (for example, the user U1). The presentation unit 123 may present the acquired attribute information to the user by transmitting the acquired attribute information, or may present the acquired attribute information to the user by image output via the display 31 or audio output via the speaker 32. Note that the presentation unit 123 may present not only the acquired attribute information but also the type of action to the user. Every time the attribute information is acquired by the acquisition unit 122, the presentation unit 123 newly presents the acquired attribute information to the user.

When the registration instruction received from the user (for example, the user U1) is a final registration instruction, the registration unit 124 registers a combination of the type of action and the attribute information in the registration information storage unit 112 as registration information related to a new object as a recognition target in association with name information designated by the user. The final registration instruction is an instruction for performing a final confirmation registration of the attribute information acquired in accordance with the advice from the user U1. Furthermore, the registration unit 124 can further associate and register the user ID acquired by the user identification unit 121 as the registration information described above. Furthermore, the registration unit 124 also functions as a provisional registration unit that performs provisional registration of a combination of the type of action and the attribute information in a case where a provisional registration instruction has been received from the user before reception of the final registration instruction. The provisional registration instruction is an instruction for provisionally registering the attribute information acquired according to the advice of the user U1. Each time of receiving a provisional registration instruction from the user, the registration unit 124 performs additional provisional registration of a combination of the type of action and the attribute information.

The specifying unit 125 refers to a combination of an action type and attribute information associated with the user (for example, the user U1) who has issued the action instruction in the registration information stored in the registration information storage unit 112, checks the matching between the attribute information acquired by the acquisition unit 122 from the candidate object and the corresponding attribute information in the registration information, and specifies the object to be the target of the action instruction from among the candidate objects on the basis of a matching degree obtained as a result of the matching check.

Although not illustrated in FIG. 4, the control unit 120 includes a motion control unit that controls the motion of the robot 1 in accordance with an action instruction from the user (for example, the user U1) with respect to the object specified by the specifying unit 125.

### 4. SPECIFIC EXAMPLE OF REGISTRATION PROCESSING PERFORMED BY ROBOT

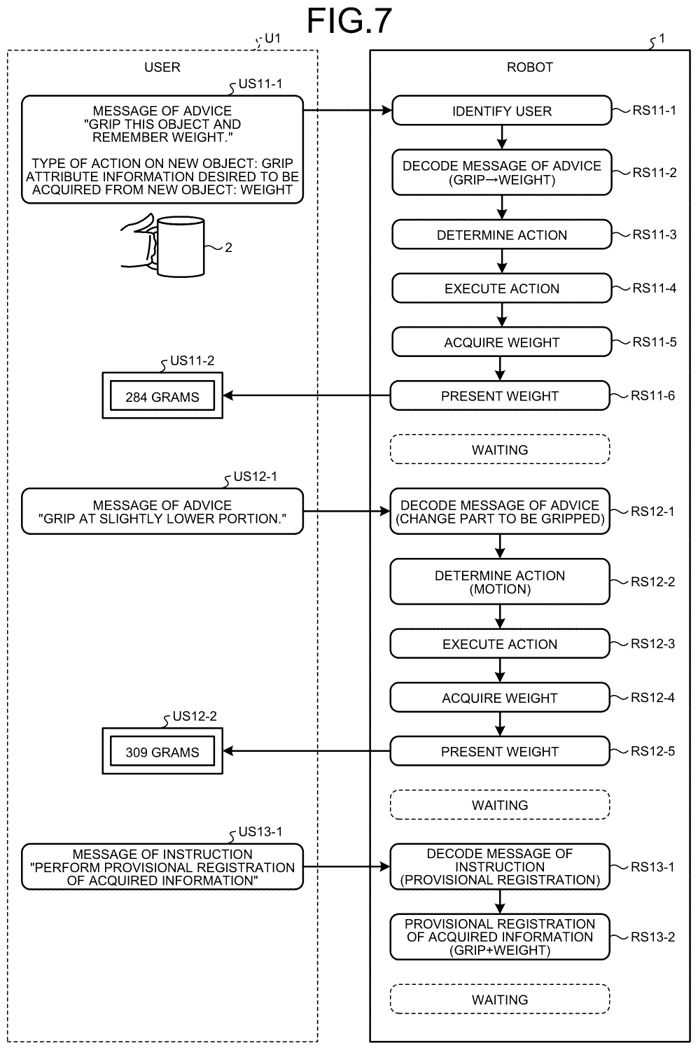

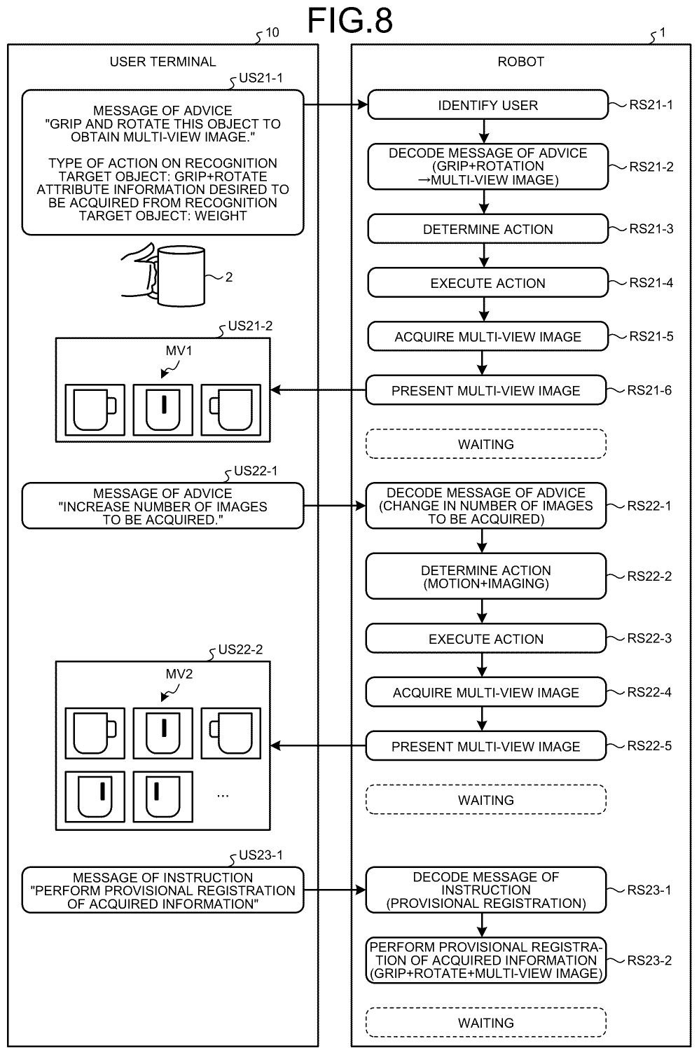

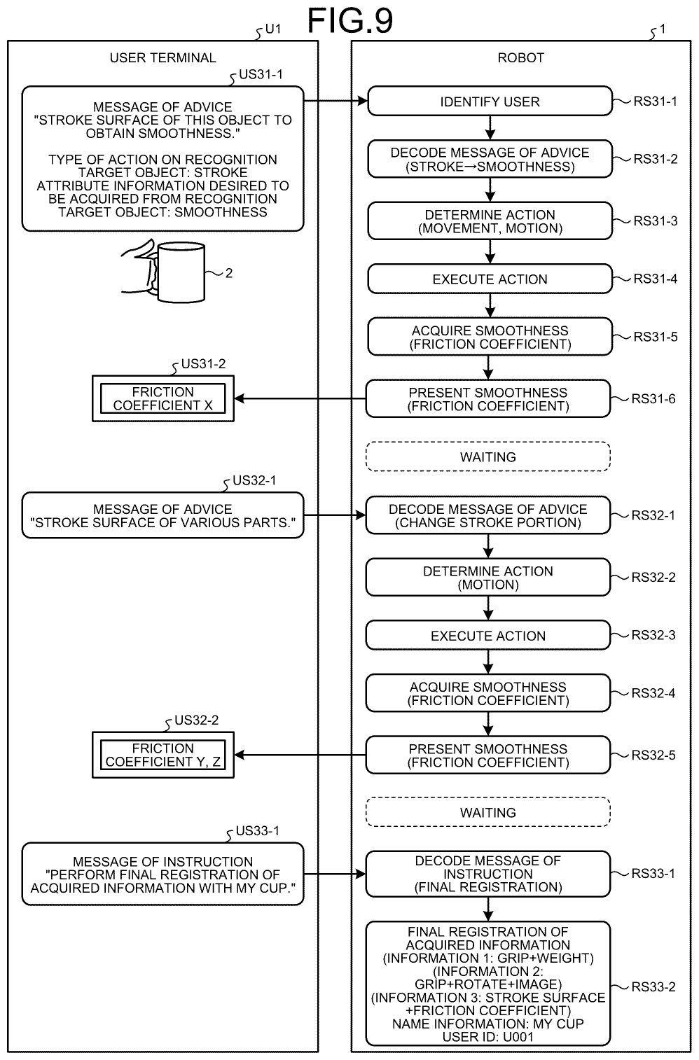

A specific example of registration processing performed by the robot according to an embodiment of the present disclosure will be described with reference to FIGS. 7 to 9. FIGS. 7 to 9 are diagrams illustrating an outline of processing of the robot in the registration processing according to an embodiment of the present disclosure. The following will describe a case where the registration processing implemented by the interaction between the user U1 and the robot 1 is constituted with three stages: phase 1 illustrated in FIG. 7, phase 2 illustrated in FIG. 8, and phase 3 illustrated in FIG. 9.

(Phase 1)

As illustrated in FIG. 7, the user U1 of the user terminal 20, for example, presents a new object 2 to be a recognition target in front of the robot 1 and gives a piece of advice of “Grip this object and remember the weight.” (US11-1). This advice includes a combination of the type of action on the new object 2: [grip] and the attribute information desired to be acquired from the new object 2: [weight].

The robot 1 identifies the user U1 who has issued the advice on the basis of the authentication information stored in the user information storage unit 111 (RS11-1). Furthermore, the robot 1 decodes the message of the advice received from the user U1 (RS11-2), determines an action according to the message of the advice (RS11-3), and executes the determined action (RS11-4).

In addition, the robot 1 acquires [weight] of the new object 2 as the attribute information of the new object 2 by the action on the new object 2 (RS11-5). In addition, the robot 1 presents the [weight] acquired from the new object 2 to the user U1 (RS11-6), and waits until the next instruction or advice is given.

The user U1 confirms whether the [weight] of the new object 2 presented from the robot 1 is appropriate, and considers alteration of the message of the advice (US11-2). As an example, when the user U1 determines that the error between the weight (for example, 284 g) of the new object 2 detected by the robot and the true weight measured in advance for the new object 2 exceeds an allowable range, the user U1 examines the message of the advice for bringing the numerical value of the weight detected by the robot 1 close to the true value while looking back on the state of the action of the robot 1. Subsequently, the user U1 gives the robot 1 a new piece of advice having a message “Grip at a slightly lower portion.” (US12-1).

Furthermore, the robot 1 decodes the message of the advice received from the user U1 (RS12-1), determines an action according to the message of the advice (RS12-2), and executes the determined action (RS12-3).

In addition, the robot 1 acquires [weight] of the new object 2 again as the attribute information of the new object 2 by the action on the new object 2 (RS12-4). In addition, the robot 1 newly presents the [weight] acquired from the new object 2 to the user U1 (RS12-5), and waits until the next instruction or advice is given.

The user U1 confirms whether the [weight] of the new object 2 presented from the robot 1 is appropriate, and considers alteration of the message of the advice (US12-1). For example, when having determined that the weight of new object 2 is appropriate, the user U1 gives an instruction of “Perform provisional registration of acquired information.” to the robot 1 (US13-1).

The robot 1 decodes the message of the instruction received from the user U1 (RS13-1), performs provisional registration of the acquired information (weight) in association with the action type (grip) according to the message of the instruction (RS13-2), and waits until the next instruction or advice is given (to be continued to phase 2).

(Phase 2)

Subsequently, as illustrated in FIG. 8, the user U1 presents the same new object 2 as in the above-described phase 1 (FIG. 7) in front of the robot 1 and gives a piece of advice having a message “Grip and rotate this object to obtain a multi-view image.” (US21-1). This advice includes a combination of the type of action on the new object 2: [grip+rotate] and attribute information desired to be acquired from the new object 2: [multi-view image].

The robot 1 identifies the user U1 who has issued the advice on the basis of the authentication information stored in the user information storage unit 111 (RS21-1). In a case where steps of FIGS. 7 and 8 are recognized as a series of processing, the robot 1 may omit user identification. For example, in a case where the robot 1 receives new advice after performing the provisional registration and before receiving the final registration instruction, the robot 1 can determine that the advice before the provisional registration and the advice after the provisional registration are a series of processing performed by the same user, and can skip the user identification processing.

Furthermore, the robot 1 decodes the message of the advice received from the user U1 (RS21-2), determines an action according to the message of the advice (RS21-3), and executes the determined action (RS21-4).

In addition, based on the action on the new object 2, the robot 1 acquires a [multi-view image] of the new object 2 as attribute information of the new object 2 (RS21-5). In addition, the robot 1 presents the [multi-view image] acquired from the new object 2 to the user U1 (RS21-6), and waits until the next instruction or advice is given.

The user U1 confirms whether the [multi-view image] of the new object 2 presented from the robot 1 is appropriate for recognizing the new object 2, and considers alteration of the message of the advice (US21-2). As an example, in a case where the user U1 has determined that the number of multi-view images MV1 to be acquired is insufficient in order to recognize the new object 2, the user U1 examines message of the advice for increasing the number of multi-view images to be acquired by the robot 1. The user U1 then gives the robot 1 a new piece of advice having a message “Increase the number of images to be acquired.” (US22-1).

Furthermore, the robot 1 decodes the message of the advice received from the user U1 (RS22-1), determines an action according to the message of the advice (RS22-2), and executes the determined action (RS22-3).

In addition, based on the action on the new object 2, the robot 1 acquires a [multi-view image] of the new object 2 again as attribute information of the new object 2 (RS22-4). In addition, the robot 1 newly presents the [multi-view image] acquired from the new object 2 to the user U1 (RS22-5), and waits until the next instruction or advice is given.

The user U1 confirms whether the [multi-view image] of the new object 2 presented from the robot 1 is appropriate, and considers alteration of the message of the advice (US22-2). For example, when having determined that the number of multi-view images MV2 of the new object 2 to be acquired is sufficient, the user U1 gives an instruction having a message “Perform provisional registration of acquired information.” to the robot 1 (US23-1).

The robot 1 decodes the message of the instruction received from the user U1 (RS23-1), performs provisional registration of the acquired information (multi-view image) in association with the action type (grip+rotate) according to the message of the instruction (RS23-2), and waits until the next instruction or advice is given (to be continued to phase 3).

(Phase 3)

Subsequently, as illustrated in FIG. 9, the user U1 presents a new object 2, which is the same as the above-described phase 1 (FIG. 7) and phase 2 (FIG. 8), in front of the robot 1 and gives a piece of advice “Stroke the surface of this object to obtain the smoothness.” (US31-1). This advice is constituted with a combination of the type of action on the new object 2: [stroke (surface)] and attribute information desired to be acquired from the new object 2: [smoothness (friction coefficient)].

The robot 1 identifies the user U1 who has issued the advice on the basis of the authentication information stored in the user information storage unit 111 (RS31-1). In a case where steps of FIGS. 7 and 8 are recognized as a series of processing, the robot 1 may omit user identification.

Furthermore, the robot 1 decodes the message of the advice received from the user U1 (RS31-2), determines an action according to the message of the advice (RS31-3), and executes the determined action (RS31-4).

In addition, based on the action on the new object 2, the robot 1 acquires the [smoothness (friction coefficient)] of the new object 2 as attribute information of the new object 2 (RS31-5). In addition, the robot 1 presents the [smoothness (friction coefficient)] acquired from the new object 2 to the user U1 (RS31-6), and waits until the next instruction or advice is given.

The user U1 confirms whether the [smoothness (friction coefficient)] of the new object 2 presented from the robot 1 is appropriate for recognizing the new object 2, and considers alteration of the message of the advice (US31-2). As an example, in a case where the user U1 has determined that the numerical value of [friction coefficient X] of the new object 2 acquired from the robot 2 is appropriate but the number of acquired friction coefficients is insufficient, the user U1 examines message of the advice for increasing the number of friction coefficients to be acquired by the robot 1. The user U1 then gives the robot 1 new advice having a message “Stroke the surface of various parts.” (US32-1).

Furthermore, the robot 1 decodes the message of the advice received from the user U1 (RS32-1), determines an action according to the message of the advice (RS32-2), and executes the determined action (RS32-3).

In addition, based on the action on the new object 2, the robot 1 again acquires the [smoothness (friction coefficient)] of the new object 2 as attribute information of the new object 2 (RS32-4). In addition, the robot 1 newly presents the [smoothness (friction coefficient)] acquired from the new object 2 to the user U1 (RS32-5) and waits until the next instruction or advice is given.

The user U1 confirms whether the [smoothness (friction coefficient)] of the new object 2 presented from the robot 1 is appropriate, and considers alteration of the message of the advice (US32-2). For example, when having determined that the number of acquired friction coefficients is sufficient by adding newly acquired friction coefficients Y and Z of the new object 2 to the previously acquired friction coefficient X, the user U1 gives an instruction “Perform final registration of acquired information with my cup.” to the robot 1 (US33-1). In this manner, the user U1 can include the name information in the final registration instruction of the registration information related to the new object 2. With this operation, the user U1 can register the uniquely designated name in association with the registration information of the new object 2. In addition, the user U1 can perform an interaction with the robot 1 using the uniquely designated name.

The robot 1 decodes the message of the instruction received from the user U1 (RS33-1), and performs final registration of information, specifically, information 1 registered by provisional registration in the above-described phase 1, information registered by provisional registration in the above-described phase 2, and information acquired in phase 3, as registration information of the new object 2 in association with the name information and the user ID designated by the user U1 (RS33-2), and ends the registration processing. The registration information of the new object 2 includes name information: [My Cup], a user ID: [U001], information 1, information 2, and information 3 in association with each other. Information 1 includes action type: [grip] and attribute information: [weight], information 2 includes action type: [grip+rotate] and attribute information: [multi-view image], and information 3 includes action type: [stroke] and attribute information: [smoothness (friction coefficient)].

### 5. EXAMPLE OF PROCESSING PROCEDURE PERFORMED BY ROBOT

<5-1. Registration Processing>

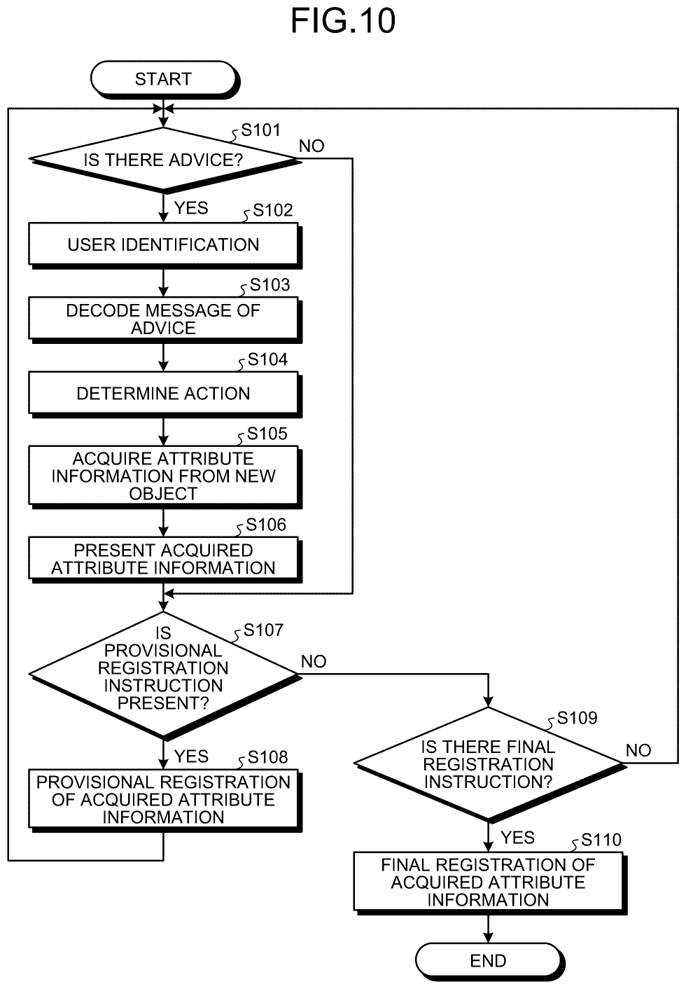

Hereinafter, a registration processing procedure example of the robot 1 according to an embodiment of the present disclosure will be described with reference to FIG. 10. FIG. 10 is a flowchart illustrating an example of a registration processing procedure performed by a robot according to an embodiment of the present disclosure. The processing procedure illustrated in FIG. 10 is mainly executed by the information processing device 10 or the like included in the robot 1.

As illustrated in FIG. 10, the user identification unit 121 determines whether any advice has been received from the user U1 (Step S101). The user identification unit 121 can determine whether any advice has been received from the user U1 by various methods. For example, the user identification unit 121 may recognize the message of the voice input from the user U1, or may analyze text information received from the user terminal 20 by text mining or the like.

When the user identification unit 121 determines that the advice from the user U1 has been received (Step S101; Yes), the user identification unit 121 identifies the user U1 who has issued the advice on the basis of authentication information stored in the user information storage unit 111 (Step S102).

The acquisition unit 122 decodes the message of the advice received from the user U1 (Step S103), and determines a subsequent action (Step S104).

Furthermore, the acquisition unit 122 takes an action in accordance with the message of the decoded advice to acquire attribute information from the new object 2 to be a recognition target (Step S105).

The presentation unit 123 presents the attribute information acquired by the acquisition unit 122 to the user U1 (Step S106). The attribute information can be presented by the presentation unit 123 by various methods such as data communication, image output, and audio output.

After presenting the attribute information, the presentation unit 123 determines whether a provisional registration instruction has been received from the user U1 (Step S107).

In a case where the presentation unit 123 determines that the provisional registration instruction has been received from the user U1 (Step S107; Yes), the presentation unit 123 performs provisional registration of the attribute information acquired in Step S105 in association with the type of action (Step S108), and returns to the processing procedure of Step S101 described above.

In contrast, in case where the presentation unit 123 determines that the provisional registration instruction has not been received from the user U1 (Step S107; No), the presentation unit 123 determines whether a final registration instruction has been received from the user U1 (Step S109).

In a case where the presentation unit 123 determines that the final registration instruction has been received from the user U1 (Step S109; Yes), the presentation unit 123 performs final registration of the attribute information acquired in Step S105 in association with the type of action, the name information, and the user ID (Step S110), and ends the processing procedure illustrated in FIG. 10.

In contrast, in a case where the presentation unit 123 determines that the final registration instruction has not been received from the user U1 (Step S109; No), the presentation unit 123 returns to the processing procedure of Step S101 described above.

When the user identification unit 121 determines, in Step S101 described above, that the advice has not been received from the user U1 (Step S101; No), the user identification unit 121 proceeds to the processing procedure of Step S107 described above. Incidentally, in the processing procedure illustrated in FIG. 10, the robot 1 may end the processing procedure illustrated in FIG. 10 after a lapse of certain time, without receiving advice or an instruction from the user.

<5-2. Recognition Processing>

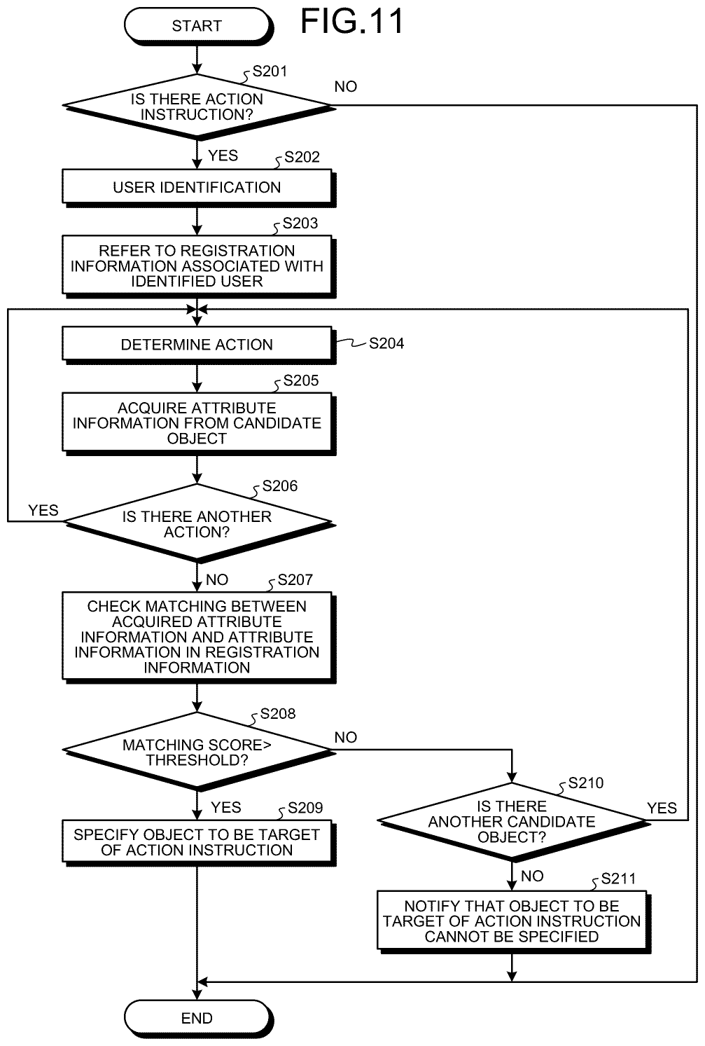

Hereinafter, a recognition processing procedure example of the robot 1 according to an embodiment of the present disclosure will be described with reference to FIG. 11. FIG. 11 is a flowchart illustrating an example of a recognition processing procedure performed by a robot according to an embodiment of the present disclosure. The processing procedure illustrated in FIG. 11 is mainly executed by the information processing device 10 or the like included in the robot 1.

As illustrated in FIG. 11, the user identification unit 121 determines whether an action instruction has been received from the user U1 (Step S201).

When the user identification unit 121 determines that an action instruction has been received from the user U1 (Step S201; Yes), the user identification unit 121 identifies the user U1 who has issued the action instruction on the basis of the authentication information stored in the user information storage unit 111 (Step S202).

The acquisition unit 122 refers to the registration information associated with the identified user U1 (Step S203), and determines a subsequent action (Step S204).

Furthermore, the acquisition unit 122 selects one type of action associated with the user U1, and acts in accordance with the selected type of action, thereby acquiring information from the candidate object to be a target of the action instruction (Step S204).

After acquiring the attribute information, the acquisition unit 122 determines whether there is another action as the type of action associated with the user U1 (Step S205).

When having determined that there is another action as the type of the action associated with the user U1 (Step S205; Yes), the acquisition unit 122 returns to the processing procedure of Step S204 described above.

In contrast, when the acquisition unit 122 determines that there is no other action as the type of action associated with the user U1 (Step S205; No), the specifying unit 125 checks the matching between the attribute information acquired in Step S204 and the attribute information in the registration information associated with the user U1 (Step S206), and calculates a matching score. When having acquired the plurality of pieces of attribute information, the acquisition unit 122 may calculate a matching score for each piece of attribute information, or may calculate one matching score by integrating the matching scores of the plurality of pieces of attribute information.

In addition, the specifying unit 125 determines whether the matching score exceeds a predetermined threshold (Step S207). In a case where there is a matching score for each piece of attribute information, the specifying unit 125 may compare each matching score with an individual threshold.

In a case where the specifying unit 125 has determined that the matching score exceeds a predetermined threshold (Step S208; Yes), the candidate object is specified as the object that is the target of the action instruction of the user U1 (Step S209) so as to end the processing procedure illustrated in FIG. 11.

In contrast, when having determined that the matching score is less than the predetermined threshold (Step S208; No), the specifying unit 125 determines whether there is another candidate object around the own device (robot 1) (Step S210).

When having determined that there is another candidate object (Step S210; Yes), the specifying unit 125 returns to the processing procedure of Step S204 described above. That is, the specifying unit 125 executes the processing procedure of Steps S204 to S208 described above for the another candidate object.

In contrast, when having determined that there is no other candidate object (Step S210; No), the specifying unit 125 notifies the user U1 that the object to be the target of the action instruction cannot be specified (Step S211) and ends the processing procedure illustrated in FIG. 11.

### 6. MODIFICATION

<6-1. Case of Registration Processing>

The information processing device 10 may register one piece of name information designated by the user U1 at the time of the final registration instruction in association with a plurality of objects. For example, attribute information of a stainless steel cup as well as attribute information of the glass cup may be registered in association with name information: “My Cup”. In this case, when having received an action instruction from the user U1 using such name information, the information processing device 10 may select registration information corresponding to the message of the action instruction according to the situation at the time of receiving the action instruction. For example, in a case where the information processing device receives an action instruction of “Take my cup” from the user U1, the information processing device 10 can acquire current season information. When the season is determined to be summer, it is possible to select attribute information corresponding to the glass cup.

<6-2. Case of Recognition Processing>

The information processing device 10 need not perform the matching check on all the plurality of pieces of attribute information recorded in the registration information when specifying the object that is the target of the action instruction. For example, it is assumed that three pieces of attribute information exist as registration information associated with the registered name: [My Cup]. In this case, when the result of matching check of the attribute information that is checked for matching first among the three pieces of attribute information is good (for example, in a case where the value exceeds the threshold), matching check need not be performed for the remaining two pieces of attribute information. In addition, in a case where the result of matching check between the attribute information that has been first checked and the attribute information that has been next checked among the three pieces of attribute information is good, the matching check need not be performed for the remaining attribute information. In addition, when a result of the matching check with at least one piece of attribute information among the three pieces of attribute information is good, the corresponding candidate object may be designated as an object to be a target of the action instruction. In this manner, by registering the plurality of pieces of attribute information in association with each other as the registration information for the object to be a recognition target, there is a case where at least one of the plurality of pieces of attribute information included in the registration information can be acquired and recognized even if there is attribute information that cannot be acquired from the candidate object, leading to achievement of an effect of enhancing robustness of the object recognition.

### 7. OTHERS

In addition, a control program for implementing the control method executed by the information processing device 10 according to the present embodiment and its modifications may be stored and distributed in a computer-readable recording medium such as an optical disk, semiconductor memory, a magnetic tape, or a flexible disk. At this time, the information processing device 10 according to the embodiment and the modifications of the present disclosure can implement the control method according to the embodiment and the modifications of the present disclosure by installing various programs in a computer and executing the programs.

In addition, various programs for implementing the control method executed by the information processing device 10 according to the present embodiment and the modifications may be stored in a disk device included in a server on a network such as the Internet and may be downloaded onto a computer. In addition, functions provided by various programs for implementing the control method executed by the information processing device 10 according to the embodiment and the modifications of the present disclosure may be implemented by cooperative operations of the OS and the application program. In this case, the sections other than the OS may be stored in a medium for distribution, or the sections other than the OS may be stored in an application server so as to be downloaded to a computer, for example.

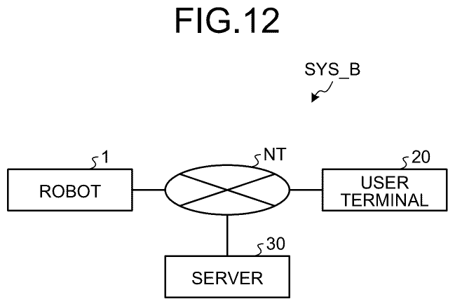

Furthermore, at least a part of the processing function for implementation of the control method executed by the information processing device 10 according to the present embodiment and the modifications may be implemented by a cloud server on a network. FIG. 12 is a diagram illustrating a configuration example of an information processing system according to a modification. As illustrated in FIG. 12, an information processing system SYS B according to the modification includes a robot 1, a user terminal 20, and a server 30. Note that the information processing system SYS B may include more robots 1, user terminals 20, and servers 30 than in the example illustrated in FIG. 12.

The robot 1, the user terminal 20, and the server 30 are connected to a network NT. The robot 1, the user terminal 20, and the server 30 can communicate through the network NT. The network NT can be implemented by applying, for example, various networks such as the Internet, a LAN, and a mobile communication network.

The server 30 is implemented by a single server device or a server group including a plurality of servers such as a cloud server. The server 30 can execute at least a part of the registration processing (refer to FIGS. 7 to 9 and the like) according to the present embodiment and the processing according to the modification. For example, the server 30 can execute various types of processing implemented by the user identification unit 121, the acquisition unit 122, the presentation unit 123, the registration unit 124, and the specifying unit 125 included in the control unit 120 included in the information processing device 10. The server 30 executes various types of processing on the basis of the data uploaded from the robot 1 and returns results of the processing to the information processing device 10 (robot 1), making it possible to implement the registration processing according to the present embodiment (refer to FIGS. 5 to 9 and the like) and the processing according to the modification. Furthermore, the server 30 can also function as cloud storage that manages information stored in the registration information storage unit 112 included in the information processing device 10.

Furthermore, among individual processing described in the present embodiment and modifications of the present disclosure, all or a part of the processing described as being performed automatically may be manually performed, or the processing described as being performed manually can be performed automatically by known methods. In addition, the processing procedures, specific names, and information including various data and parameters illustrated in the above Literatures or drawings can be arbitrarily altered unless otherwise specified. For example, a variety of information illustrated in each of the drawings are not limited to the information illustrated.

In addition, each component of the information processing device 10 according to the present embodiment and modifications is functionally conceptual, and is not necessarily required to be configured as illustrated in the drawings. For example, the user identification unit 121, the acquisition unit 122, the presentation unit 123, and the registration unit 124 of the control unit 120 included in the information processing device 10 may be functionally or physically integrated to each other.

Furthermore, the present embodiment and modifications can be appropriately combined within a range implementable without contradiction of processes. Furthermore, the order of individual steps illustrated in the flowcharts of the above-described embodiments of the present disclosure can be changed as appropriate.

The present embodiment and modifications have been described above. However, the technical scope of the present disclosure is not limited to the above-described embodiments or their modifications and various modifications can be made without departing from the scope of the present disclosure. Moreover, it is allowable to combine the components across different embodiments and modifications as appropriate.

### 8. CONCLUSION

The information processing device 10 according to the present embodiment and modifications includes the registration information storage unit 112, the acquisition unit 122, the presentation unit 123, and the registration unit 124. The registration information storage unit 112 stores registration information related to a recognition target object. The acquisition unit 122 acquires attribute information indicating the property of the new object to be a recognition target in accordance with the message of the advice received from the user. The presentation unit 123 presents the attribute information acquired by the acquisition unit 122 to the user. In accordance with a registration instruction received from the user, the registration unit 124 associates attribute information with name information designated by the user, and registers the associated information in the registration information storage unit 112 as registration information of a new object. This enables desired information that the user considers to be useful for recognizing the object to be selectively registered in the information processing device 10 for the new object to be the recognition target. This leads to achievement of an effect of improving the object recognition accuracy of the information processing device 10.

The advice received by the information processing device 10 from the user includes a combination of the type of action on the new object and attribute information desired to be acquired from the new object. The acquisition unit 122 acquires attribute information from the new object by acting in accordance with the type of action constituting the advice. The registration unit 124 registers a combination of an action type and attribute information in accordance with the registration instruction. With this configuration, the information processing device 10 can easily acquire an action of acquiring information for recognizing an object.

The acquisition unit 122 additionally acquires attribute information each time advice is received from the user. In addition, every time the attribute information is acquired by the acquisition unit 122, the presentation unit 123 newly presents the acquired attribute information to the user. Moreover, every time a provisional registration instruction, which is an instruction to provisionally register the acquired information, is received from the user, the registration unit 124 adds and performs provisional registration of a combination of the type of action and the attribute information. This makes it possible for the information processing device 10 to register a plurality of pieces of information used for recognition for the new object as a recognition target.

The information processing device 10 further includes the user information storage unit 111 and the user identification unit 121. The user information storage unit 111 stores, for each user, user identification information (user ID) assigned to the user in advance and authentication information unique to the user in association with each other. The user identification unit 121 identifies the user who has issued a piece of advice on the basis of the authentication information, and acquires user identification information corresponding to the identified user from among a plurality of pieces of user identification information stored in the user information storage unit 111. The registration unit 124 further associates and registers the user identification information as registration information.

In addition, the user identification unit 121 uses a face image of the user as the authentication information. This makes it possible to recognize the user using the camera 22 included in the robot 1 without a new device on the robot 1.

In addition, when having received an action instruction from the user, the user identification unit 121 identifies the user who has issued the action instruction on the basis of the authentication information. In addition, the acquisition unit 122 acquires the attribute information from the candidate object that is the target of the action instruction by acting in accordance with the type of action associated with the user identified by the user identification unit 121 in the registration information stored in the registration information storage unit 112. The information processing device 10 further includes the specifying unit 125. The specifying unit 125 refers to a combination of an action type and attribute information associated with the user who has issued the action instruction in the registration information, checks the matching between the attribute information acquired by the acquisition unit 122 from the candidate object and the corresponding attribute information in the registration information, and specifies the object to be the target of the action instruction on the basis of a matching degree obtained as a result of the matching check. This makes it possible for the information processing device 10 to easily and accurately specify the object that is the target of the action instruction using the registration information.

When a plurality of types of actions exists, the acquisition unit 122 acquires information from the candidate object by acting in accordance with each of the types of actions. The specifying unit 125 checks the matching between the plurality of pieces of attribute information acquired from the candidate object by the acquisition unit 122 and the corresponding pieces of attribute information in the registration information. With this configuration, there is a case where at least one of the plurality of pieces of attribute information included in the registration information can be acquired and recognized by the information processing device 10 even if there is attribute information that cannot be acquired from the candidate object, leading to achievement of an effect of enhancing robustness of the object recognition.

Furthermore, the registration unit 124 registers registration information of different new objects in association with an identical name information. In addition, in a case where there is a plurality of pieces of registration information associated with the identical name information, the specifying unit 125 selects the registration information on the basis of the situation at the time of receiving the action instruction. With this operation, the same type of object as the recognition sun can be registered with the identical registered name, and usability can be improved.

The effects described in the present specification are merely illustrative or exemplary and are not limited. That is, the technology according to the present disclosure can exhibit other effects that are apparent to those skilled in the art from the description of the present specification in addition to or instead of the above effects.

Note that the technology of the present disclosure can also have the following configurations as belonging to the technical scope of the present disclosure.

(1)

An information processing device comprising:
a registration information storage unit that stores registration information related to an object to be a recognition target;
an acquisition unit that acquires attribute information indicating a property of a new object to be a recognition target in accordance with a message of advice received from a user; and
a presentation unit that presents the attribute information acquired by the acquisition unit to a user; and
a registration unit that associates the attribute information with name information designated by the user in accordance with a registration instruction received from the user and that registers the associated information in the registration information storage unit as the registration information.
   (2)

The information processing device according to (1),
wherein the advice is constituted with a combination of a type of action on the new object and the attribute information desired to be acquired from the new object,
the acquisition unit acquires the attribute information from the new object by taking an action in accordance with the type of action constituting the advice, and
the registration unit registers the combination of the type of action and the attribute information in association with the name information in accordance with the registration instruction.
   (3)

The information processing device according to (2),
wherein the acquisition unit additionally acquires the attribute information every time the advice is received from the user,
the presentation unit newly presents the acquired attribute information to the user every time the acquisition unit acquires the attribute information, and
the registration unit additionally performs registration, as provisional registration, of a combination of the action type and the attribute information every time a provisional registration instruction, which is an instruction to provisionally register acquired information, is received from the user.
   (4)

The information processing device according to any one of (1) and (3), further comprising:
a user information storage unit that stores, for each user, user identification information assigned to the user in advance and authentication information unique to the user in association with each other; and
a user identification unit that identifies a user who has issued the advice on the basis of the authentication information and that acquires the user identification information corresponding to the identified user from among a plurality of pieces of the user identification information stored in the user information storage unit,
wherein the registration unit further associates and registers the user identification information as the registration information.
   (5)

The information processing device according to (4),
wherein the user identification unit uses a face image of a user as the authentication information.
   (6)

The information processing device according to (4),
wherein, when the user identification unit has received an action instruction from a user, the user identification unit identifies a user who has issued the action instruction on a basis of the authentication information, and
the acquisition unit
takes an action according to the type of the action associated with the user identified by the user identification unit in the registration information stored in the registration information storage unit, and acquires, by this action, the attribute information from a candidate object to be a target of the action instruction, and
further includes a specifying unit that refers to a combination of the type of the action associated with the user who has issued the action instruction in the registration information and the attribute information, checks matching between the attribute information acquired from the candidate object by the acquisition unit and the corresponding attribute information in the registration information, and specifies an object to be a target of the action instruction on a basis of a matching degree obtained as a result of the matching check.
   (7)

The information processing device according to (6),
wherein, in a case where a plurality of types of actions exists, the acquisition unit takes an action according to each type of the action so as to acquire a plurality of pieces of the attribute information from the candidate object; and
the specifying unit checks matching individually between the plurality of pieces of attribute information acquired from the candidate object by the acquisition unit and the corresponding pieces of attribute information in the registration information.
   (8)

The information processing device according to (6),
wherein the registration unit registers the registration information of mutually different new objects in association with the name information which is identical name information, and
in a case where there is a plurality of pieces of the registration information associated with the identical name information, the specifying unit selects the registration information on a basis of a situation at reception of the action instruction.
   (9)

An information processing method, implemented by a processor, the method comprising:
acquiring attribute information indicating a property of a new object to be a recognition target in accordance with a message of advice received from a user;
presenting the attribute information acquired to a user; and
associating the attribute information with name information designated by the user in accordance with a registration instruction received from the user and registering the associated information as registration information related to the object to be the recognition target.
   (10)

An information processing program that causes a processor to execute processing comprising:
acquiring attribute information indicating a property of a new object to be a recognition target in accordance with a message of advice received from a user;
presenting the attribute information acquired to a user; and
associating the attribute information with name information designated by the user in accordance with a registration instruction received from the user and registering the associated information as registration information related to the object to be the recognition target.

### REFERENCE SIGNS LIST

1 ROBOT
10 INFORMATION PROCESSING DEVICE
11 SIGNAL PROCESSING CIRCUIT
12 CPU
13 DRAM
14 FLASH ROM
15 USB CONNECTOR
16 WIRELESS COMMUNICATION UNIT
21 MICROPHONE
22 CAMERA
23 DISTANCE SENSOR
24 TACTILE SENSOR
25 PRESSURE SENSOR
26 FORCE SENSOR
30 SERVER
31 DISPLAY
32 SPEAKER
41 MOVABLE PORTION
42 ACTUATOR
43 ENCODER
110 STORAGE UNIT
111 USER INFORMATION STORAGE UNIT
112 REGISTRATION INFORMATION STORAGE UNIT
120 CONTROL UNIT
121 USER IDENTIFICATION UNIT
122 ACQUISITION UNIT
123 PRESENTATION UNIT
124 REGISTRATION UNIT
125 SPECIFYING UNIT
130 SENSOR UNIT
140 INPUT UNIT
150 OUTPUT UNIT
160 COMMUNICATION UNIT
170 MOTION UNIT

1. An information processing device comprising:
a registration information storage unit that stores registration information related to an object to be a recognition target;
an acquisition unit that acquires attribute information indicating a property of a new object to be a recognition target in accordance with a message of advice received from a user; and
a presentation unit that presents the attribute information acquired by the acquisition unit to a user; and
a registration unit that associates the attribute information with name information designated by the user in accordance with a registration instruction received from the user and that registers the associated information in the registration information storage unit as the registration information.

2. The information processing device according to claim 1,
wherein the advice is constituted with a combination of a type of action on the new object and the attribute information desired to be acquired from the new object,
the acquisition unit acquires the attribute information from the new object by taking an action in accordance with the type of action constituting the advice, and
the registration unit registers the combination of the type of action and the attribute information in association with the name information in accordance with the registration instruction.

3. The information processing device according to claim 2,
wherein the acquisition unit additionally acquires the attribute information every time the advice is received from the user,
the presentation unit newly presents the acquired attribute information to the user every time the acquisition unit acquires the attribute information, and
the registration unit additionally performs registration, as provisional registration, of a combination of the action type and the attribute information every time a provisional registration instruction, which is an instruction to provisionally register acquired information, is received from the user.

4. The information processing device according to claim 3, further comprising:
a user information storage unit that stores, for each user, user identification information assigned to the user in advance and authentication information unique to the user in association with each other; and
a user identification unit that identifies a user who has issued the advice on the basis of the authentication information and that acquires the user identification information corresponding to the identified user from among a plurality of pieces of the user identification information stored in the user information storage unit,
wherein the registration unit further associates and registers the user identification information as the registration information.

5. The information processing device according to claim 4,
wherein the user identification unit uses a face image of a user as the authentication information.

6. The information processing device according to claim 4,
wherein, when the user identification unit has received an action instruction from a user, the user identification unit identifies a user who has issued the action instruction on a basis of the authentication information, and
the acquisition unit
takes an action according to the type of the action associated with the user identified by the user identification unit in the registration information stored in the registration information storage unit, and acquires, by this action, the attribute information from a candidate object to be a target of the action instruction, and
further includes a specifying unit that refers to a combination of the type of the action associated with the user who has issued the action instruction in the registration information and the attribute information, checks matching between the attribute information acquired from the candidate object by the acquisition unit and the corresponding attribute information in the registration information, and specifies an object to be a target of the action instruction on a basis of a matching degree obtained as a result of the matching check.

7. The information processing device according to claim 6,
wherein, in a case where a plurality of types of actions exists, the acquisition unit takes an action according to each type of the action so as to acquire a plurality of pieces of the attribute information from the candidate object; and
the specifying unit checks matching individually between the plurality of pieces of attribute information acquired from the candidate object by the acquisition unit and the corresponding pieces of attribute information in the registration information.

8. The information processing device according to claim 6,
wherein the registration unit registers the registration information of mutually different new objects in association with the name information which is identical name information, and
in a case where there is a plurality of pieces of the registration information associated with the identical name information, the specifying unit selects the registration information on a basis of a situation at reception of the action instruction.

9. An information processing method, implemented by a processor, the method comprising:
acquiring attribute information indicating a property of a new object to be a recognition target in accordance with a message of advice received from a user;
presenting the attribute information acquired to a user; and
associating the attribute information with name information designated by the user in accordance with a registration instruction received from the user and registering the associated information as registration information related to the object to be the recognition target.

10. An information processing program that causes a processor to execute processing comprising:
acquiring attribute information indicating a property of a new object to be a recognition target in accordance with a message of advice received from a user;
presenting the attribute information acquired to a user; and
associating the attribute information with name information designated by the user in accordance with a registration instruction received from the user and registering the associated information as registration information related to the object to be the recognition target.
